(19) United States
(12) Patent Application Publication
(10) Pub. No.: US 2023/0395345 A1
(43) Pub. Date: Dec. 7, 2023

(54) An Electronically Operated Switch for Long-term Use

(71) Applicant: Yi-Fan Chang, Zhubei City (TW)

(72) Inventor: Yi-Fan Chang, Zhubei City (TW)

(21) Appl. No.: 18/031,320

(22) PCT Filed: Oct. 13, 2021
(86) PCT No.: PCT/CN2021/123614

§ 371 Date: Apr. 11, 2023

(30) Foreign Application Priority Data
Oct. 16, 2020 (CN) 202011111571.4

(51) Int. Cl. H01H 45/12; H01H 45/02

(52) U.S. Cl. CPC H01H 45/12; H01H 45/02

(57) ABSTRACT

The present invention relates to an electrically operated switch, and particularly to an electrically operated switch for long-term use comprising a first electrically conductive heat-dissipating fin, a second electrically conductive heat-dissipating fin, and a plurality of relays. All the input terminals on the plurality of relays are interconnected through the first electrically conductive heat-dissipating fin, and all the output terminals on the plurality of relays are interconnected through the second electrically conductive heat-dissipating fin. In the present invention, the plurality of relays is interconnected through a first electrically conductive heat-dissipating fin and a second electrically conductive heat-dissipating fin. The first electrically conductive heat-dissipating fin and the second electrically conductive heat-dissipating fin may not only perform electrical conduction but may also speedily dissipate heat from the contacts on the plurality of relays to allow the plurality of relays to operate under long-term high current flow without getting burned.

### BACKGROUND OF THE INVENTION

### 1. Field of the Invention

The present invention relates to an electrically operated switch, and particularly to an electrically operated switch for long-term use.

### 2. Description of Related Art

In existing technology, a conventional relay may endure high current flow, but contacts disposed thereon may not endure the heat generated by long-term high current flow. Therefore, they may be burned when long-term high current flow is required, for example when operating a power generator in cold areas.

### SUMMARY OF THE INVENTION

To solve the foregoing problem in existing technology, the present invention provides an electrically operated switch for long-term use that may endure long-term high current flow.

To solve the foregoing technological problem, the present invention provides an electrically operated switch for long-term use comprising a first electrically conductive heat-dissipating fin, a second electrically conductive heat-dissipating fin, and a plurality of relays, wherein all the input terminals on the plurality of relays are interconnected through the first electrically conductive heat-dissipating fin, and all the output terminals on the plurality of relays are interconnected through the second electrically conductive heat-dissipating tin.

Preferably, the foregoing first electrically conductive heat-dissipating fin is made of copper or aluminum.

Preferably, the foregoing second electrically conductive heat-dissipating fin is made of copper or aluminum.

Preferably, the foregoing first electrically conductive heat-dissipating fin has a thickness that is greater than or equal to 0.5 mm.

Preferably, the foregoing second electrically conductive heat-dissipating tin has a thickness that is greater than or equal to 0.5 mm.

Preferably, the foregoing electrically operated switch for long-term use further includes a PCB, thereon are disposed a plurality of first through holes for the input terminals to pass through and a plurality of second through holes for the output terminals to pass through.

Preferably, the foregoing electrically operated switch for long-term use further includes a plurality of soldering points, wherein an input terminal on a relay connects to the first electrically conductive heat-dissipating fin through a soldering point, and an output terminal on a relay connects to the second electrically conductive heat-dissipating fin through a soldering point.

Preferably, on the first electrically conductive heat-dissipating fin are disposed a plurality of first connecting holes, wherein an input terminal of a relay passes through a first connecting hole and connects to a soldering point.

Preferably, on the second electrically conductive heat-dissipating fin are disposed a plurality of second connecting holes, wherein an output terminal of a relay passes through a second connecting hole and connects to a soldering point.

The present invention provides the following effects. The plurality of relays is interconnected through a first electrically conductive heat-dissipating fin and a second electrically conductive heat-dissipating fin. The first electrically conductive heat-dissipating fin and the second electrically conductive heat-dissipating fin may not only perform electrical conduction but may also speedily dissipate heat from the con acts on the plurality of relays to allow the plurality of relays to operate under long-term high current flow without getting burned.

### BRIEF DESCRIPTION OF THE DRAWINGS

FIG. 1 is a three-dimensional structural drawing of the present invention;

FIG. 2 is a three-dimensional structural drawing of the present invention without showing soldering points;

FIG. 3 is a three-dimensional structural drawing of the present invention without showing soldering points, a first electrically conductive heat-dissipating fin, and a second electrically conductive heat-dissipating fin.

### DETAILED DESCRIPTION OF THE INVENTION

The present invention will be fully understood from the detailed description given herein below and the accompanying drawings, which are given by way of illustration only and thus are not limitative of the present invention.

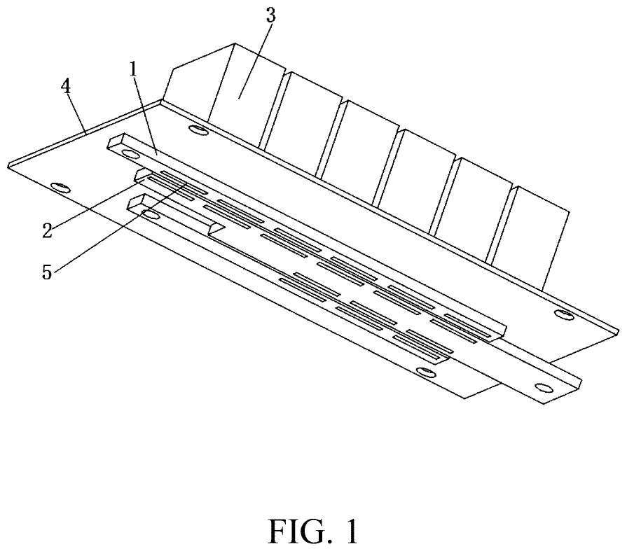

As FIG. 1 shows, an electrically operated switch for long-term use comprises a first electrically conductive heat-dissipating fin 1, a second electrically conductive heat-dissipating fin 2, and a plurality of relays 3, wherein all the input terminals (not shown in the drawing) on the plurality of relays 3 are interconnected through the first electrically conductive heat-dissipating fin 1, and all the output terminals (not shown in the drawing) on the plurality of relays 3 are interconnected through the second electrically conductive heat-dissipating fin 2. Thereby interconnectivity of the plurality of relays 3 is achieved.

The foregoing interconnectivity of the plurality of relays 3 may distribute high current flow to reduce the load on each of the plurality of relays 3. Meanwhile, the first electrically conductive heat-dissipating fin 1 and the second electrically conductive heat-dissipating fin 2 may not only perform electrical conduction but may also speedily dissipate heat from the contacts on the plurality of relays 3 to prevent the plurality of relays 3 to get burned as a result of the heat generated by long-term high current flow.

Specifically, a foregoing first electrically conductive heat-dissipating fin 1 is made of copper or aluminum, and a foregoing second electrically conductive heat-dissipating fin 2 is made of copper or aluminum.

Specifically, to guarantee the heat-dissipating capability of the foregoing first electrically conductive heat-dissipating fin 1 and second electrically conductive heat-dissipating fin 2, the first electrically conductive heat-dissipating fin 1 is provided with a thickness that is greater than or equal to 0.5 mm, and the second electrically conductive heat-dissipating fin 2 is provided with a thickness that is greater than or equal to 0.5 mm.

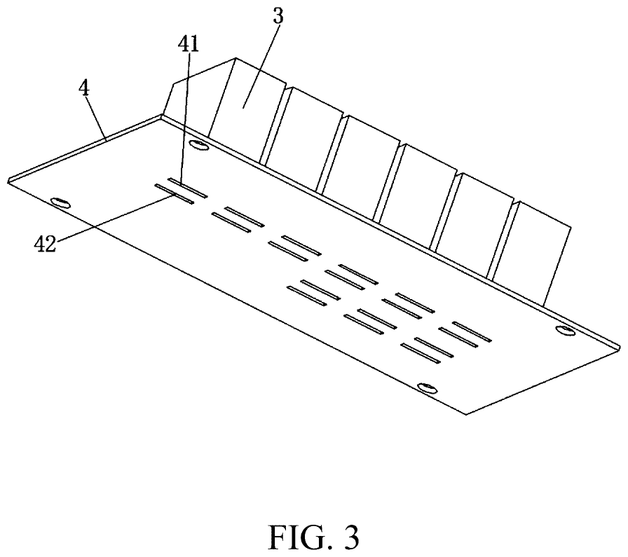

As FIGS. 1 to 3 show, a foregoing electrically operated switch for long-term use further includes a PCB 4, thereon are disposed a plurality of first through holes 41 for the input terminals on the plurality of relays 3 to pass through and a plurality of second through holes 42 for the output terminals on the plurality of relays 3 to pass through. Thereby the plurality of relays 3 is retained by the PCB 4 and prevented from dislocation. Meanwhile, the plurality of interconnected relays 3 may also be connected to other components via the PCB 4.

As FIG. 1 shows, a foregoing electrically operated switch for long-term use further includes a plurality of soldering points 5, wherein an input terminal on a relay 3 connects to the first electrically conductive heat-dissipating fin 1 through a soldering point 5, and an output terminal on a relay 3 connects to the second electrically conductive heat-dissipating fin 2 through a soldering point 5. The soldering points 5 are provided on the first electrically conductive heat-dissipating fin 1 and the second electrically conductive heat-dissipating fin 2.

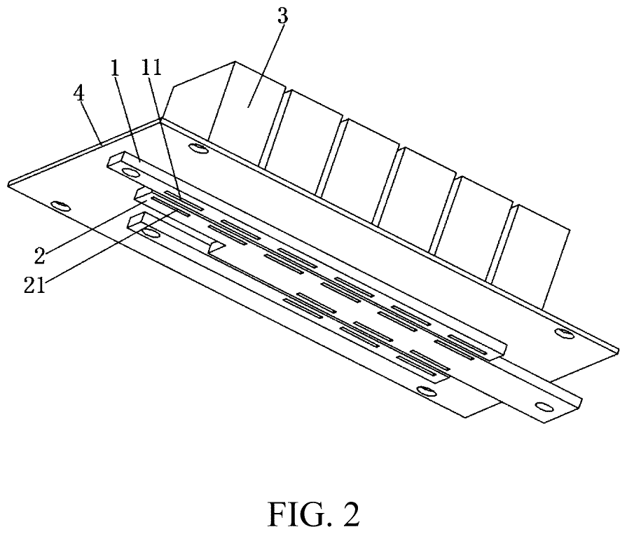

As FIG. 2 shows, on the first electrically conductive heat-dissipating fin 1 are disposed a plurality of first connecting holes 11, wherein an input terminal of a relay 3 passes through a first connecting hole 11 and connects to a soldering point 5. And on the second electrically conductive heat-dissipating fin 2 are disposed a plurality of second connecting holes 21, wherein an output terminal of a relay 3 passes through a second connecting hole 21 and connects to a soldering point 5. Thereby the plurality of relays 3 may be prevented from obstructing soldering on the one hand, and the stability of the plurality of relays 3 may be greatly enhanced to prevent dislocation on the other hand.

The foregoing preferred embodiment of the present invention is illustrated of the present invention rather than limiting of the present invention. They are intended to cover various modifications and changes included within the spirit and scope of the appended claims, the scope of which should be accorded the broadest interpretation so as to encompass all such modifications and similar structures.

What is claimed is:

1. An electrically operated switch for long-term use comprising:
a first electrically conductive heat-dissipating fin;
a second electrically conductive heat-dissipating fin; and
a plurality of relays;
wherein all the input terminals on the plurality of relays are interconnected through the first electrically conductive heat-dissipating fin; and all the output terminals on the plurality of relays are interconnected through the second electrically conductive heat-dissipating fin.

2. An electrically operated switch for long-term use of claim 1, wherein the first electrically conductive heat-dissipating fin is made of copper or aluminum.

3. An electrically operated switch for long-term use of claim 1, wherein the second electrically conductive heat-dissipating fin is made of copper or aluminum.

4. An electrically operated switch for long-term use of claim 1, wherein the first electrically conductive heat-dissipating fin has a thickness that is greater than or equal to 0.5 mm.

5. An electrically operated switch for long-term use of claim 1, wherein the second electrically conductive heat-dissipating fin has a thickness that is greater than or equal to 0.5 mm.

6. An electrically operated switch for long-terra use of claim 1, further comprising a PCB, thereon are disposed a plurality of first through holes for the input terminals to pass through and a plurality of second through holes for the output terminals to pass through.

7. An electrically operated switch for long-term use of claim 1, further comprising a plurality of soldering points, wherein an input terminal on a relay connects to the first electrically conductive heat-dissipating fin through a soldering point, and an output terminal on a relay connects to the second electrically conductive heat-dissipating fin through a soldering point.

8. An electrically operated switch for long-term use of claim 1, wherein on the first electrically conductive heat-dissipating fin are disposed a plurality of first connecting holes so that an input terminal of a relay passes through a first connecting hole and connects to a soldering point.

9. An electrically operated switch for long-term use of claim 1, wherein on the second electrically conductive heat-dissipating fin are disposed a plurality of second connecting holes so that an output terminal of a relay passes through a second connecting hole and connects to a soldering point.
